(19) United States
(12) Patent Application Publication
(10) Pub. No.: US 2024/0188175 A1
(43) Pub. Date: Jun. 6, 2024

(54) QUALITY OF EXPERIENCE OPERATIONS HANDLING FOR AN INACTIVE STATE

(71) Applicant: QUALCOMM Incorporated, San Diego, CA (US)

(72) Inventors: Jianhua LIU, Beijing (CN); Shankar KRISHNAN, San Diego, CA (US); Xipeng ZHU, San Diego, CA (US); Rajeev KUMAR, San Diego, CA (US)

(21) Appl. No.: 18/551,145

(22) PCT Filed: May 8, 2021
(86) PCT No.: PCT/CN2021/092350

§ 371 Date: Sep. 18, 2023

(51) Int. Cl. H04W 76/27; H04W 24/10; H04W 36/30

(52) U.S. Cl. CPC H04W 76/27; H04W 24/10; H04W 36/30

(57) ABSTRACT

Various aspects of the present disclosure generally relate to wireless communication. In some aspects, a user equipment (UE) may receive, from a first base station prior to entering an inactive state, one or more quality of experience (QoE) configurations. The UE may perform, based at least in part on transitioning from the inactive state to a connected state with a second base station, at least one operation for the one or more QoE configurations. Numerous other aspects are described.

### FIELD OF THE DISCLOSURE

Aspects of the present disclosure generally relate to wireless communication and to techniques and apparatuses for quality of experience (QoE) reporting handling for an inactive state.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory and one or more processors, coupled to the memory, configured to: receive, from a first base station prior to entering an inactive state, one or more quality of experience (QoE) configurations; and perform, based at least in part on transitioning from the inactive state to a connected state with a second base station, at least one operation for the one or more QoE configurations.

In some aspects, a base station for wireless communication includes a memory and one or more processors, coupled to the memory, configured to: receive, from another base station that supports one or more QoE configurations of a UE, a UE context of the UE; and transmit, to the UE based at least in part on the UE transitioning from an inactive state to a connected state with the base station, a message for resuming a connection of the UE with the base station.

In some aspects, a base station for wireless communication includes a memory and one or more processors, coupled to the memory, configured to: receive, from another base station, a request for a UE context, the UE context including a QoE context of the UE; and transmit, to the other base station, the UE context including the QoE context or the UE context with the QoE context, or a portion of the QoE context, released.

In some aspects, a base station for wireless communication includes a memory and one or more processors, coupled to the memory, configured to: transmit, to another base station, a request for a UE context, the UE context including a QoE context of the UE; and receive, from the other base station, the UE context including the QoE context or the UE context with the QoE context, or a portion of the QoE context, released.

In some aspects, a method of wireless communication performed by a UE includes receiving, from a first base station prior to entering an inactive state, one or more QoE configurations; and performing, based at least in part on transitioning from the inactive state to a connected state with a second base station, at least one operation for the one or more QoE configurations.

In some aspects, a method of wireless communication performed by a base station includes receiving, from another base station that supports one or more QoE configurations of a UE, a UE context of the UE; and transmitting, to the UE based at least in part on the UE transitioning from an inactive state to a connected state with the base station, a message for resuming a connection of the UE with the base station.

In some aspects, a method of wireless communication performed by a base station includes receiving, from another base station, a request for a UE context, the UE context including a QoE context of the UE; and transmitting, to the other base station, the UE context including the QoE context or the UE context with the QoE context, or a portion of the QoE context, released.

In some aspects, a method of wireless communication performed by a base station includes transmitting, to another base station, a request for a UE context, the UE context including a QoE context of the UE; and receiving, from the other base station, the UE context including the QoE context or the UE context with the QoE context, or a portion of the QoE context, released.

In some aspects, a non-transitory computer-readable medium storing a set of instructions for wireless communication includes one or more instructions that, when executed by one or more processors of a UE, cause the UE to: receive, from a first base station prior to entering an inactive state, one or more QoE configurations; and perform, based at least in part on transitioning from the inactive state to a connected state with a second base station, at least one operation for the one or more QoE configurations.

In some aspects, a non-transitory computer-readable medium storing a set of instructions for wireless communication includes one or more instructions that, when executed by one or more processors of a base station, cause the base station to: receive, from another base station that supports one or more QoE configurations of a UE, a UE context of the UE; and transmit, to the UE based at least in part on the UE transitioning from an inactive state to a connected state with the base station, a message for resuming a connection of the UE with the base station.

In some aspects, a non-transitory computer-readable medium storing a set of instructions for wireless communication includes one or more instructions that, when executed by one or more processors of a base station, cause the base station to: receive, from another base station, a request for a UE context, the UE context including a QoE context of the UE; and transmit, to the other base station, the UE context including the QoE context or the UE context with the QoE context, or a portion of the QoE context, released.

In some aspects, a non-transitory computer-readable medium storing a set of instructions for wireless communication includes one or more instructions that, when executed by one or more processors of a base station, cause the base station to: transmit, to another base station, a request for a UE context, the UE context including a QoE context of the UE; and receive, from the other base station, the UE context including the QoE context or the UE context with the QoE context, or a portion of the QoE context, released.

In some aspects, an apparatus for wireless communication includes means for receiving, from a first base station prior to entering an inactive state, one or more QoE configurations; and means for performing, based at least in part on transitioning from the inactive state to a connected state with a second base station, at least one operation for the one or more QoE configurations.

In some aspects, an apparatus for wireless communication includes means for receiving, from a base station that supports one or more QoE configurations of a UE, a UE context of the UE; and means for transmitting, to the UE based at least in part on the UE transitioning from an inactive state to a connected state with the apparatus, a message for resuming a connection of the UE with the base station.

In some aspects, an apparatus for wireless communication includes means for receiving, from a base station, a request for a UE context, the UE context including a QoE context of the UE; and means for transmitting, to the base station, the UE context including the QoE context or the UE context with the QoE context, or a portion of the QoE context, released.

In some aspects, an apparatus for wireless communication includes means for transmitting, to a base station, a request for a UE context, the UE context including a QoE context of the UE; and means for receiving, from the base station, the UE context including the QoE context or the UE context with the QoE context, or a portion of the QoE context, released.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antenna, RF chains, power amplifiers, modulators, buffer, processor(s), interleaver, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of a wireless network in which a UE may support additional communication modes, in accordance with various aspects of the present disclosure.

FIG. 4 is a diagram illustrating an example of quality of experience (QoE) measurement configuration and QoE reporting, in accordance with the present disclosure.

FIG. 5 is a diagram illustrating an example associated with QoE operations handling for an inactive state, in accordance with the present disclosure.

FIGS. 6-9 are diagrams illustrating example processes associated with QoE operations handling for an inactive state, in accordance with the present disclosure.

FIGS. 10-12 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

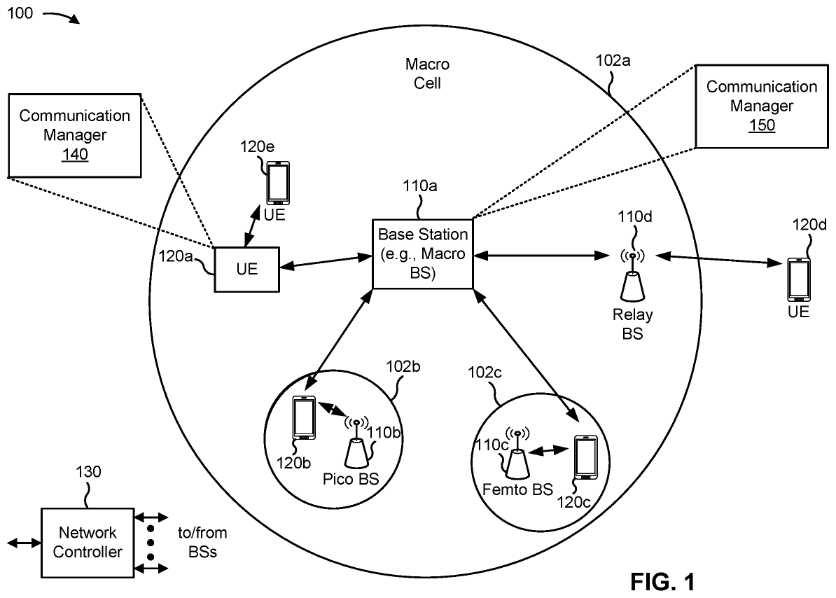

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrow band internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHZ, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHZ, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHZ). It is contemplated that the frequencies included in FR1 and FR2 may be modified, and techniques described herein are applicable to those modified frequency ranges.

In some aspects, the UE 120 may include a communication manager 140. As described in more detail elsewhere herein, the communication manager 140 may receive, from a first base station prior to entering an inactive state, one or more quality of experience (QoE) configurations; and/or perform, based at least in part on transitioning from the inactive state to a connected state with a second base station, at least one operation for the one or more QoE configurations. Additionally, or alternatively, the communication manager 140 may perform one or more other operations described herein.

In some aspects, the base station 110 may include a communication manager 150. As described in more detail elsewhere herein, the communication manager 150 may receive, from another base station that supports one or more QoE configurations of a UE, a UE context of the UE; and/or transmit, to the UE based at least in part on the UE transitioning from an inactive state to a connected state with the base station, a message for resuming a connection of the UE with the base station. Additionally, or alternatively, as described in more detail elsewhere herein, the communication manager 150 may receive, from another base station, a request for a UE context, the UE context including a QoE context of the UE; and/or transmit, to the other base station, the UE context including the QoE context or the UE context with the QoE context, or a portion of the QoE context, released. Additionally, or alternatively, as described in more detail elsewhere herein, the communication manager 150 may transmit, to another base station, a request for a UE context, the UE context including a QoE context of the UE; and/or receive, from the other base station, the UE context including the QoE context or the UE context with the QoE context, or a portion of the QoE context, released. Additionally, or alternatively, the communication manager 150 may perform one or more other operations described herein.

As indicated above, FIG. 1 is provided as an example. Other examples may differ from what is described with regard to FIG. 1.

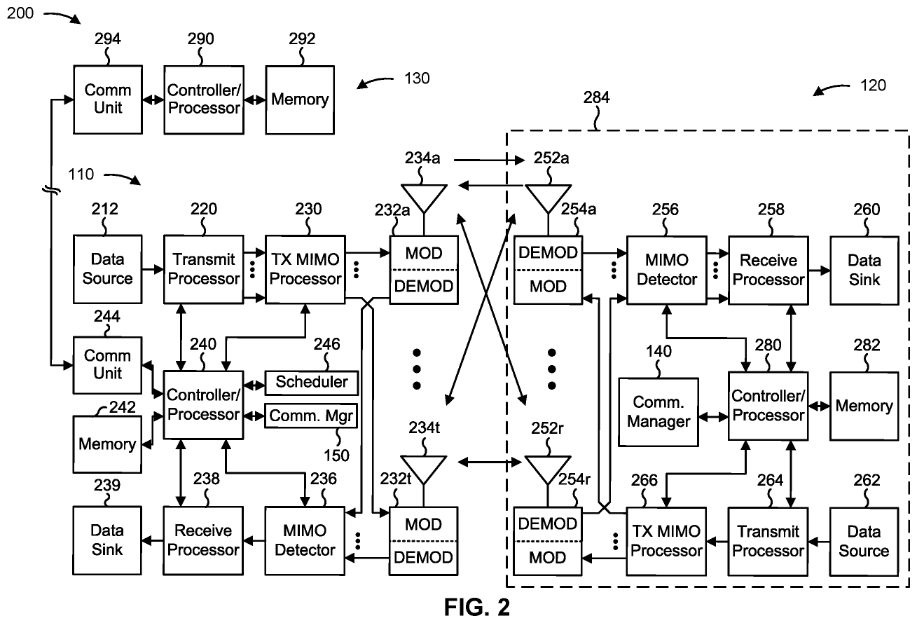

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

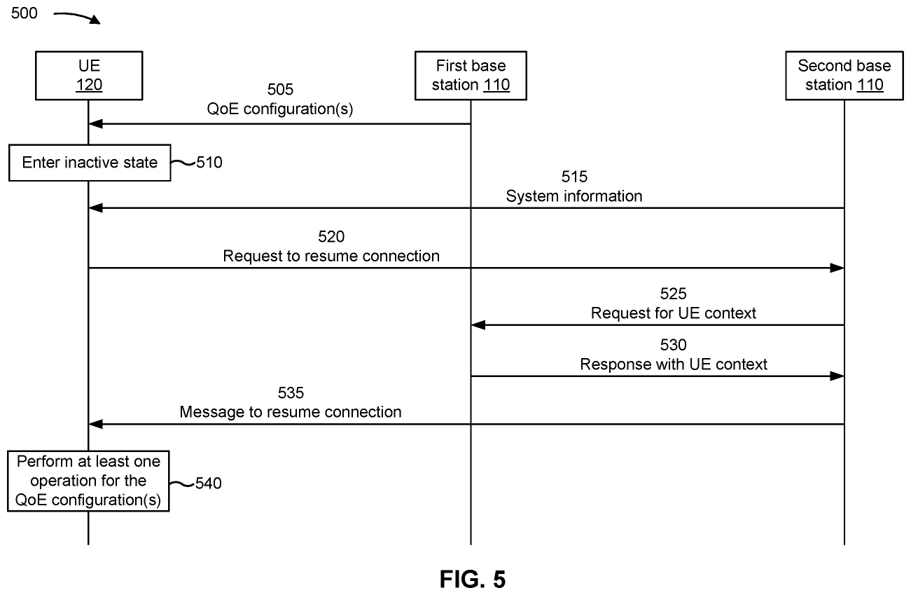

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 5-9.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 5-9.

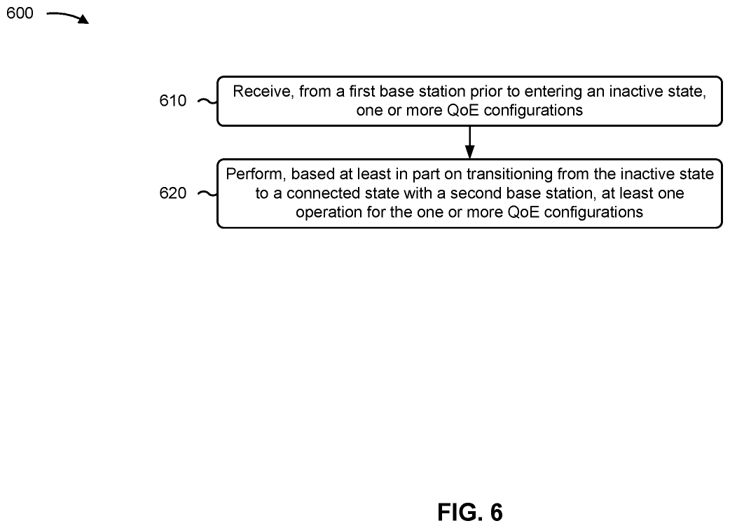

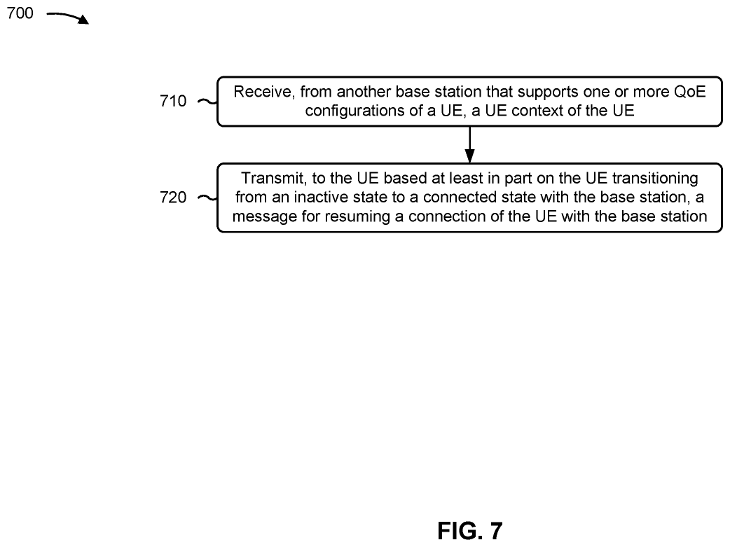

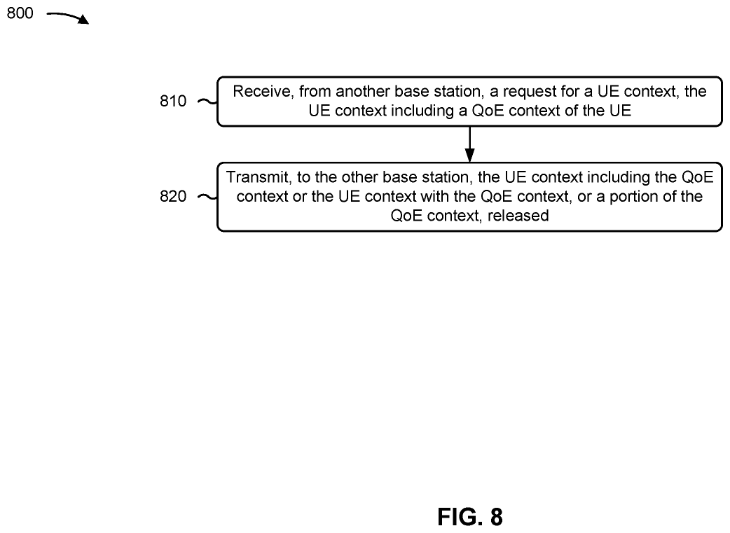

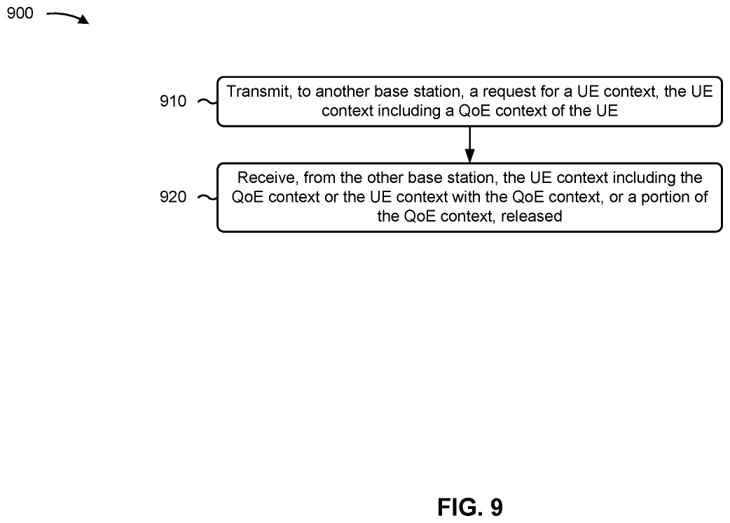

Controller/processor 240 of base station 110, controller/processor 280 of UE 120, and/or any other component(s) of FIG. 2 may perform one or more techniques associated with QoE operations handling for an inactive state, as described in more detail elsewhere herein. For example, controller/processor 240 of base station 110, controller/processor 280 of UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, process 800 of FIG. 8, process 900 of FIG. 9, and/or other processes as described herein. In some aspects, executing instructions may include running the instructions, converting the instructions, compiling the instructions, and/or interpreting the instructions, among other examples.

In some aspects, the UE includes means for receiving, from a first base station prior to entering an inactive state, one or more QoE configurations; and/or means for performing, based at least in part on transitioning from the inactive state to a connected state with a second base station, at least one operation for the one or more QoE configurations. The means for the UE to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the base station includes means for receiving, from another base station that supports one or more QoE configurations of a UE, a UE context of the UE; and/or means for transmitting, to the UE based at least in part on the UE transitioning from an inactive state to a connected state with the base station, a message for resuming a connection of the UE with the base station. In some aspects, the base station includes means for receiving, from another base station, a request for a UE context, the UE context including a QoE context of the UE; and/or means for transmitting, to the other base station, the UE context including the QoE context or the UE context with the QoE context, or a portion of the QoE context, released. In some aspects, the base station includes means for transmitting, to another base station, a request for a UE context, the UE context including a QoE context of the UE; and/or means for receiving, from the other base station, the UE context including the QoE context or the UE context with the QoE context, or a portion of the QoE context, released. The means for the base station to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

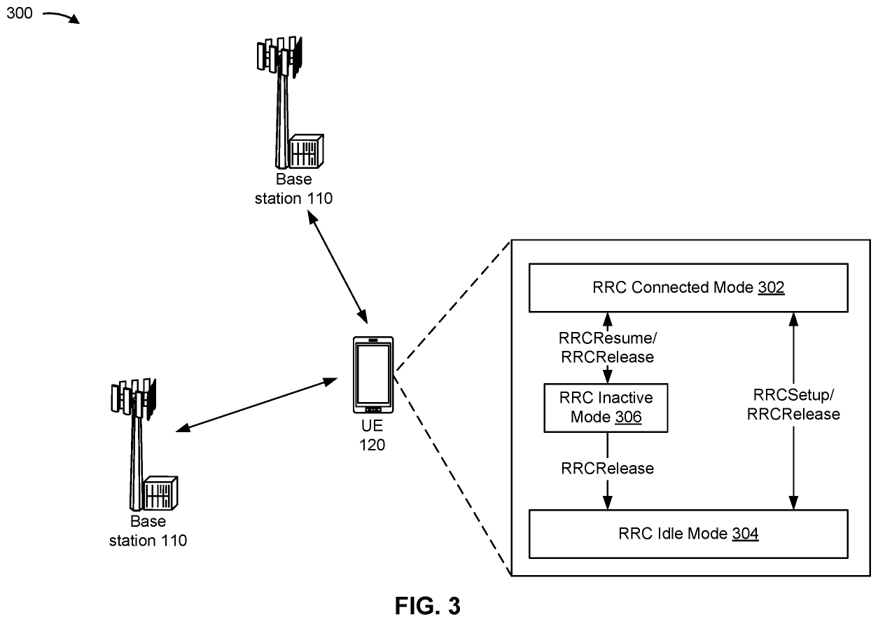

FIG. 3 illustrates an example 300 of a wireless network (e.g., wireless network 100) in which a UE 120 may support communication modes. The UE 120 may be communicatively connected with one or more base stations 110 in the wireless network (e.g., at the same, such as in a dual connectivity mode, or sequentially).

As illustrated in FIG. 3, the UE 120 may support a connected communication mode (e.g., a radio resource control (RRC) connected mode 302), an idle communication mode (e.g., an RRC idle mode 304), an inactive communication mode (e.g., an RRC inactive mode 306), or the like. The RRC inactive mode 306 may functionally reside between the RRC connected mode 302 and the RRC idle mode 304.

The UE 120 may transition between different modes based at least in part on various commands and/or communications received from the one or more base stations 110. For example, the UE 120 may transition from RRC connected mode 302 or RRC inactive mode 306 to RRC idle mode 304 based at least in part on receiving an RRC release communication (e.g., an RRCRelease message). As another example, the UE 120 may transition from RRC connected mode 302 to RRC inactive mode 306 based at least in part on receiving an RRC release communication with a configuration suspension (e.g., an RRCRelease with suspendConfig message). As another example, the UE 120 may transition from RRC idle mode 304 to RRC connected mode 302 based at least in part on receiving an RRC connection setup communication (e.g., an RRCSetup message). As another example, the UE 120 may transition from RRC inactive mode 306 to RRC connected mode 302 based at least in part on receiving an RRC resume communication (e.g., an RRCResume message).

When transitioning to RRC inactive mode 306, the UE 120 and/or a serving base station 110 may store a UE 120 context (e.g., an access stratum (AS) context, higher-layer configurations, or the like). This permits the UE 120, the base station 110, and/or a new base station 110 to apply the stored UE 120 context when the UE 120 transitions from RRC inactive mode 306 to RRC connected mode 302 in order to resume communications, which reduces latency of transitioning to RRC connected mode 302 relative to transitioning to the RRC connected mode 302 from RRC idle mode 304.

As indicated above, FIG. 3 is provided as an example. Other examples may differ from what is described with regard to FIG. 3.

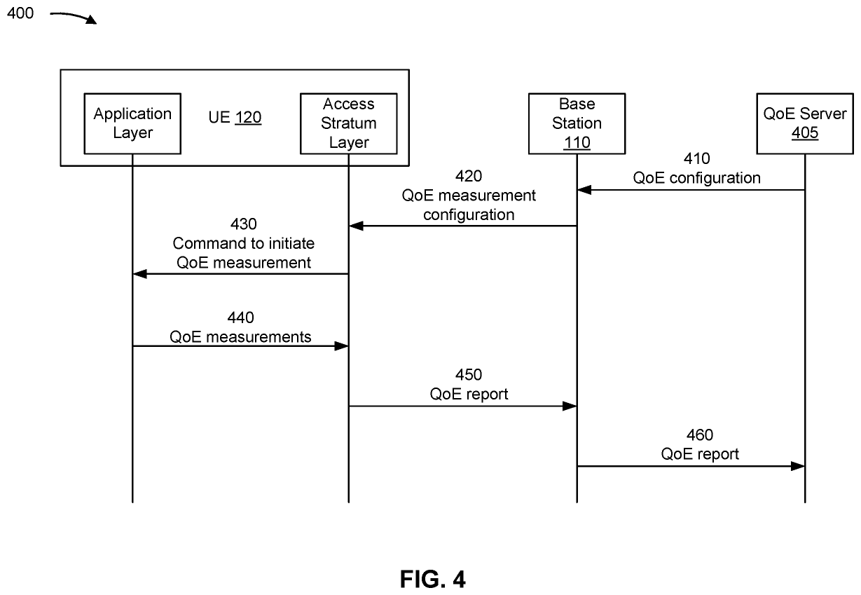

FIG. 4 is a diagram illustrating an example 400 of QoE measurement configuration and QoE reporting, in accordance with the present disclosure. QoE may refer to a level of satisfaction of a user with a service from the user's perspective. Example 400 may include communication between a QoE server 405, a base station 110, and a UE 120. The QoE server 405 may be associated with a network operator that uses the base station 110 (e.g., the QoE server 405 may be associated with an operations, administration, and maintenance (OAM) system, a control node, or the like). The QoE server 405 may perform operations associated with QoE measurements, such as processing of the QoE information, analysis of the QoE information, determination of key performance indicators (KPIs) based on the QoE information, or the like. The UE 120 may be operating in an RRC connected (e.g., RRC_CONNECTED) state (e.g., in the RRC connected mode, described in connection with FIG. 3). In addition, the UE 120 may be configured with a signaling radio bearer (SRB), for QoE reporting (e.g., SRB4), for the base station 110.

As shown by reference number 410, the base station 110 may receive, from the QoE server 405, information that identifies a QoE configuration that is to be used by the base station 110 (e.g., for configuring UEs for QoE reporting). For example, the QoE server 405 may transmit to the base station 110 an application-layer QoE measurement configuration, for a UE, that is encapsulated in a transparent container. As shown by reference number 420, the base station 110 may transmit, and the UE 120 may receive (e.g., at an access stratum layer of the UE), a QoE measurement configuration (e.g., a QoE measurement configuration based at least in part on the QoE configuration received by the base station 110). For example, the base station 110 may forward to the UE the application-layer QoE measurement configuration received from the QoE server 405 (e.g., in a downlink RRC message). As an example, the base station 110 may transmit an RRC reconfiguration (e.g., RRCReconfiguration) message that indicates the QoE measurement configuration in a measConfigAppLayer information element.

The QoE measurement configuration may identify one or more QoE measurements (e.g., relating to a quality of streaming services used in the UE 120) that are to be collected by the UE 120. A QoE measurement may refer to a measurement (e.g., relating to bit rate, drop rate, connection failure, jitter, playback time, or the like) that is for use in determining a QoE, a QoE metric, a QoE KPI, or the like. The QoE measurement configuration also may identify one or more service types (e.g., a multimedia telephony service for internet protocol multimedia subsystem (MTSI), a streaming service, and/or a multimedia broadcast multicast service (MBMS), among other examples) for which the UE 120 is to perform QoE measurements.

As shown by reference number 430, the UE 120, via the access stratum layer, may provide a command to initiate QoE measurement to an application layer of the UE 120. That is, the command may be a command to initiate QoE measurement collection (QMC). The command may be a mobile station modem (MSM) interface/attention (AT) command. As shown by reference number 440, the UE 120, via the application layer, may provide QoE measurements to the access stratum layer. The QoE measurements may be per service type indicated by the QoE measurement configuration.

As shown by reference number 450, the UE 120 may transmit (e.g., using the access stratum layer), and the base station 110 may receive, a QoE report. For example, the UE may encapsulate the application-layer measurements from the UE's higher layer in a transparent container that is transmitted to the base station 110 (e.g., in an uplink RRC message). As an example, the UE 120 may transmit a measReportAppLayer message that indicates the QoE report. The QoE report may be based at least in part on the QoE measurements collected by the UE 120. For example, the QoE report may identify the QoE measurements collected by the UE 120 (e.g., per service type). The UE 120 may transmit the QoE report via the SRB for QoE reporting (e.g., SRB4), which is a separate SRB (e.g., separate from current NR SRBs) for the lower-priority (e.g., relative to other SRB transmissions) QoE reporting. In some examples, the base station 110 may transmit to the UE 120 (e.g., via RRC signaling) an indication to pause or resume QoE reporting. As shown by reference number 460, the base station 110 may transmit the QoE report, or information associated with the QoE report, to the QoE server 405.

As described herein, a UE context (e.g., a UE AS context) of the UE 120 may be stored by the base station 110. The UE context may include a QoE context of the UE (e.g., indicating a QoE configuration of the UE or the like). In some examples, after being configured for QoE measurement and reporting by the base station 110, the UE 120 may enter an inactive state (e.g., in the RRC inactive mode, described in connection with FIG. 3). However, when transitioning from the inactive state to the connected state, the UE 120 may resume a connection (e.g., an RRC connection) with a new base station 110 (or other RAN node) that does not support QoE operations or does not support the QoE configuration of the UE 120. In some cases, the UE 120 may resume a connection with a new base station 110 (or other RAN node) that supports QoE operations and/or the QoE configuration of the UE 120, but that is experiencing overload and therefore may need to reduce or terminate QoE reporting of the UE 120.

However, wireless networks generally lack support for techniques to signal, configure, or otherwise handle QoE reporting of the UE 120 when the UE 120 resumes a connection (e.g., by performing an RRC resume procedure) with a base station 110 that does not support QoE operations or cannot accommodate QoE reporting of the UE 120. As a result, the UE 120 may continue to perform QoE measurement in accordance with the QoE configuration, thereby consuming processing resources of the UE 120, even though the measurements cannot be reported by the UE.

Described herein are techniques and apparatuses for handling QoE context and QoE reporting of a UE when the UE resumes a connection from an inactive state. For example, some techniques and apparatuses described herein enable handling of QoE context and QoE reporting of a UE when the UE resumes a connection to a base station that does not support QoE operations, does not support (e.g., wholly or partially) one or more QoE configurations of the UE, and/or cannot accommodate (e.g., wholly or partially) QoE reporting of the UE (e.g., due to overload).

In some aspects, when the base station retrieves a UE context of the UE from a last serving base station, the last serving base station may transmit the UE context with the QoE context, or a portion thereof, released if the base station does not support QoE operations and/or does not support one or more QoE configurations of the UE. Here, if the base station does not support QoE operations, the UE may release all QoE configurations. Otherwise, if the base station supports QoE operations, the base station may transmit to the UE a message (e.g., an RRC resume message) that includes an explicit indication of whether the UE is to release one or more QoE configurations.

In some aspects, the last serving base station may transmit the UE context with the QoE context regardless of whether the base station supports QoE operations and/or supports the QoE configurations of the UE, and the base station may ignore (e.g., discard) the QoE context, or a portion thereof, that is not supported. Here, if the base station does not support QoE operations, the UE may suspend all QoE configurations, or resume measurement for all QoE configurations but pause reporting for the QoE configurations. Otherwise, if the base station supports QoE operations, the base station may transmit to the UE a message (e.g., an RRC resume message) that includes an explicit indication of whether the UE is to suspend one or more QoE configurations, or whether the UE is to resume measurement for one or more QoE configurations but pause reporting for the one or more QoE configurations.

In some aspects, the UE may autonomously release, suspend, or pause one or more QoE configurations based at least in part on a RAT implemented by the base station. For example, the UE may release, suspend, or pause one or more QoE configurations that are not supported by an Evolved Universal Mobile Telecommunications System (UMTS) Terrestrial Radio Access Network (E-UTRAN) RAT, such as LTE. In some aspects, the base station may transmit system information that indicates whether the base station supports QoE operations, and the UE may release, suspend, or pause one or more QoE configurations based at least in part on whether the base station supports QoE operations.

In this way, QoE reporting of the UE is efficiently managed when the UE resumes a connection to a base station from an inactive state. For example, the UE may perform one or more operations in connection with one or more QoE configurations based at least in part on whether the base station supports QoE operations, based at least in part on whether the base station supports one or more QoE configurations of the UE, and/or based at least in part on whether the base station is experiencing overload. Accordingly, processing resources of the UE, used for QoE measurement, and/or network resources for QoE reporting, are conserved or otherwise used efficiently.

As indicated above, FIG. 4 is provided as an example. Other examples may differ from what is described with respect to FIG. 4.

FIG. 5 is a diagram illustrating an example 500 associated with QoE operations handling for an inactive state, in accordance with the present disclosure. As shown in FIG. 5, example 500 includes communication between a first base station 110, a second base station 110, and a UE 120. In some aspects, the first base station 110, the second base station 110, and the UE 120 may be included in a wireless network, such as wireless network 100. The first base station 110 and the UE 120, and/or the second base station 110 and the UE 120, may communicate via a wireless access link, which may include an uplink and a downlink. The first base station 110 and the second base station 110 may communicate via a backhaul interface (e.g., an X2 interface). The first base station 110 and the second base station 110 may be different TRPs of a base station, different base stations, different RAN nodes, or the like.

As shown by reference number 505, the first base station 110 may transmit, and the UE 120 may receive, one or more QoE configurations (e.g., one or more QoE measurement configurations, one or more QoE reporting configurations, or the like). The one or more QoE configurations may be for one or more service types. For example, the one or more service types may include an MTSI service, a streaming service, an MBMS service, a network slice-related service, and/or an extended reality (XR) service, among other examples. In some aspects, one or more of the service types may be supported by a first RAT (e.g., an NR RAT), but may not be supported by a second RAT (e.g., an E-UTRAN RAT). In some aspects, the first base station 110 may configure an SRB for QoE reporting (e.g., SRB4) by the UE 120.

In some aspects, the first base station 110 may support (e.g., fully support) the one or more QoE configurations. For example, the first base station 110 may implement the first RAT (e.g., NR). In some aspects, in connection with configuring the one or more QoE configurations for the UE 120, the first base station 110 may store a UE context (e.g., a UE AS context), associated with the UE 120, that includes a QoE context (e.g., indicating the one or more QoE configurations for the UE 120).

In some aspects, the UE 120 may receive the one or more QoE configurations prior to entering an inactive state (e.g., an RRC inactive mode, as described in connection with FIG. 3). As shown by reference number 510, the UE 120 may enter an inactive state (e.g., an RRC inactive mode, as described in connection with FIG. 3). For example, after receiving the one or more QoE configurations from the first base station 110, the UE 120 may enter the inactive state. In the inactive state, a session of the UE 120 may be suspended (e.g., unicast data transmissions to and from the UE 120 may be suspended).

The UE 120 may transition from the inactive state to a connected state (e.g., an RRC connected mode, as described in connection with FIG. 3). In the connected state, the session of the UE 120 may be resumed (e.g., unicast data transmissions to and from the UE 120 may be resumed). The UE 120 may transition to the connected state (e.g., resume a connection of the UE 120) with the second base station 110 (e.g., a new cell). For example, the UE 120 may transition to the connected state by performing a procedure for resuming a connection of the UE 120 with the second base station 110. In some aspects, the second base station 110 may not support QoE operations, may not support one or more QoE configurations of the UE 120, and/or cannot accommodate (e.g., due to overloading) QoE reporting for one or more QoE configurations of the UE.

In some aspects, prior to performing the procedure for resuming the connection, as shown by reference number 515, the second base station 110 may transmit, and the UE 120 may receive, system information (e.g., a system information message, such as a system information block (SIB)) for the second base station 110. For example, the system information may indicate whether the second base station 110 supports QoE operations. As another example, the system information may indicate QoE operation capabilities of the second base station 110. Accordingly, the UE 120 may determine whether the second base station 110 supports QoE operations, or which QoE operations the second base station 110 supports, based at least in part on the system information.

As part of the procedure for resuming the connection, as shown by reference number 520, the UE 120 may transmit, and the second base station 110 may receive, a request to resume the connection (e.g., an RRCResumeRequest message). In response to the request to resume the connection, the second base station 110 may perform a procedure to retrieve the UE context of the UE 120 with the first base station 110 (e.g., the last serving cell of the UE 120). As shown by reference number 525, as part of the procedure to retrieve the UE context, the second base station 110 may transmit, and the first base station 110 may receive, a request for the UE context (e.g., a Retrieve UE Context Request message).

As shown by reference number 530, as part of the procedure to retrieve the UE context, the first base station 110 may transmit, and the second base station 110 may receive, a response with the UE context (e.g., a Retrieve UE Context Response message). In some aspects, the first base station 110 may transmit the UE context including the QoE context of the UE 120. In some aspects, the first base station 110 may transmit the UE context with the QoE context, or a portion thereof, released (e.g., the first base station 110 may transmit the UE context without the QoE context or a portion thereof).

The first base station 110 may transmit the UE context including the QoE context or transmit the UE context with the QoE context, or portion thereof, released (e.g., transmit an updated UE context) based at least in part on whether the second base station 110 supports QoE operations and/or based at least in part on a QoE operation capability of the second base station 110. For example, the first base station 110 may transmit the UE context including the QoE context based at least in part on a determination (e.g., according to QoE operation capabilities of the second base station 110) that the second base station 110 supports QoE operations in accordance with the QoE context of the UE 120 (e.g., the second base station 110 supports QoE operations and supports the one or more QoE configurations of the UE 120). As another example, the first base station 110 may transmit the UE context with the QoE context released based at least in part on a determination (e.g., according to QoE operation capabilities of the second base station 110) that the second base station 110 does not support QoE operations in accordance with the QoE context of the UE 120 (e.g., the second base station 110 does not support QoE operations and/or does not support the one or more QoE configurations of the UE 120). As a further example, the first base station 110 may transmit the UE context with a portion of the QoE context released based at least in part on a determination (e.g., according to QoE operation capabilities of the second base station 110) that the second base station 110 does not support the portion of the QoE context (e.g., the second base station 110 does not support one or more of the QoE configurations of the UE 120).

The second base station 110 may support QoE operations if a RAT implemented by the second base station 110 includes operations associated with QoE. The second base station 110 may support a QoE configuration if the second base station 110 supports QoE measurement reporting in accordance with the QoE configuration (e.g., the second base station 110 is capable of recognizing and/or processing a QoE report in accordance with the QoE configuration). In some aspects, the first base station 110 may store information indicating the QoE operation capabilities of the second base station 110, and the first base station 110 may transmit the UE context, as described above, based at least in part on the information. In some aspects, the first base station 110 may obtain the information from an OAM system, the network controller 130, another control node, or the like.

In some aspects, the first base station 110 may transmit the UE context including the QoE context regardless of whether the second base station 110 supports QoE operations in accordance with the QoE context of the UE 120 (e.g., regardless of whether the second base station 110 supports QoE operations and/or supports the one or more QoE configurations of the UE 120). That is, the first base station 110 may forward the UE context to the second base station 110. In some aspects, the second base station 110 may discard (e.g., ignore) the QoE context, or a portion thereof, if the second base station 110 does not support QoE operations in accordance with the QoE context. For example, the second base station 110 may discard the QoE context if the second base station 110 does not support QoE operations and/or does not support the one or more QoE configurations of the UE 120. As another example, the second base station 11 may discard a portion of the QoE context if the second base station 110 does not support one or more of the QoE configurations of the UE 120.

As shown by reference number 535, based at least in part on receiving the UE context of the UE, and as part of the procedure for resuming the connection of the UE 120, the second base station 110 may transmit, and the UE 120 may receive, a message to resume the connection of the UE 120 with the second base station 110 (e.g., an RRCResume message). The UE 120 may transition to the connected state based at least in part on receiving the message to resume the connection.

In some aspects, the message may include an indication relating to QoE. Here, the message including the indication relating to QoE may indicate that the second base station 110 supports QoE operations. Accordingly, the UE 120 may determine that the second base station 110 supports QoE operations based at least in part on the message including the indication relating to QoE. In some aspects, the message may not include the indication relating to QoE. Here, the message lacking the indication relating to QoE may indicate that the second base station 110 does not support QoE operations. Accordingly, the UE 120 may determine that the second base station 110 does not support QoE operations based at least in part on the message lacking the indication relating to QoE.

The second base station 110 can use the indication relating to QoE to tailor the QoE reporting of the UE 120 to that which is supported by the second base station 110 (e.g., according to QoE operation capabilities of the second base station 110) and/or to tailor the QoE reporting of the UE 120 to that which can be accommodated by the second base station 110 (e.g., if the second base station 110 is experiencing overloading). Accordingly, the UE 120 may refrain from performing QoE measurement or reporting that is not supported by, or available for, the second base station 110, thereby conserving processing resources of the UE 120 associated with QoE measurement and/or network resources associated with QoE reporting.

In some aspects, as described above, the second base station 110 receives the UE context with the QoE context, or with the QoE context or a portion thereof released, in accordance with a QoE operation capability of the second base station 110. Here, a scheme of indications from the second base station 110 and operations of the UE 120, may be referred to as a “resume/release” scheme. In some aspects, as described above, the second base station 110 receives the UE context with the QoE context regardless of a QoE operation capability of the second base station 110. Here, a first scheme of indications from the second base station 110 and operations of the UE 120 may be referred to as a “resume/suspend” scheme, or a second scheme of indications from the second base station 110 and operations of the UE 120 may be referred to as a “resume/pause” scheme.

In the resume/release scheme, the indication relating to QoE may indicate (e.g., using a single indication) that the UE 120 is to resume measurement and reporting for all QoE configurations of the UE 120; the indication relating to QoE may indicate at least one QoE configuration, of the one or more QoE configurations, that is to be released by the UE 120; the indication relating to QoE may indicate at least one QoE configuration, of the one or more QoE configurations, for which measurement and reporting is to be resumed by the UE 120; and/or the indication relating to QoE may indicate one or more new QoE configurations for the UE 120.

In the resume/suspend scheme, the indication relating to QoE may indicate (e.g., using a single indication) that the UE 120 is to resume measurement and reporting for all QoE configurations of the UE 120; the indication relating to QoE may indicate at least one QoE configuration, of the one or more QoE configurations, that is to be released (or suspended) by the UE 120; and/or the indication relating to QoE may indicate at least one QoE configuration, of the one or more QoE configurations, for which measurement and reporting is to be resumed by the UE 120.

In the resume/pause scheme, the indication relating to QoE may indicate (e.g., using a single indication) that the UE 120 is to resume measurement and reporting for all QoE configurations of the UE 120; the indication relating to QoE may indicate (e.g., using a single indication) that the UE 120 is to pause reporting for all QoE configurations of the UE 120; the indication relating to QoE may indicate at least one QoE configuration, of the one or more QoE configurations, for which the UE 120 is to pause reporting; and/or the indication relating to QoE may indicate at least one QoE configuration, of the one or more QoE configurations, for which the UE 120 is to resume reporting.

As shown by reference number 540, the UE 120 may perform (e.g., in connection with transitioning from the inactive state to the connected state) at least one operation for the one or more QoE configurations of the UE 120. In some aspects, the UE 120 may perform the at least one operation based at least in part on whether the second base station 110 supports QoE operations. In some aspects, the UE 120 may perform the at least one operation based at least in part on the indication relating to QoE in the message received from the second base station 110 as part of the procedure for resuming the connection of the UE 120.

In some aspects, the system information received by the UE 120 indicates whether the second base station 110 supports QoE operations, as described above. Here, the UE 120, to perform the operation(s), may release (e.g., delete) and/or suspend (e.g., deactivate) all QoE configurations of the UE 120 based at least in part on the system information indicating that the second base station 110 does not support QoE operations. Additionally, or alternatively, the UE 120, to perform the operation(s), may resume measurement (e.g., perform measurements) for all QoE configurations of the UE 120, but pause reporting (e.g., refrain from reporting) for all QoE configurations of the UE 120, based at least in part on the system information indicating that the second base station 110 does not support QoE operations. In some aspects, the UE 120, to perform the operation(s), may resume measurement and reporting for all QoE configurations of the UE 120 (e.g., the UE 120 may perform measurements, resume SRB4, and resume QoE reporting) based at least in part on the system information message indicating that the second base station 110 supports QoE operations. That is, the UE 120 may resume measurement and reporting for all QoE configurations provided that there is no indication relating to QoE, in the message received from the second base station 110, indicating otherwise.

In some aspects, the UE 120 may obtain information indicating a RAT used by the second base station 110 (e.g., from the first base station 110, from the system information transmitted by the second base station 110, or the like). In some aspects, the UE 120 may determine whether the second base station 110 supports QoE operations and/or determine QoE operation capabilities of the second base station 110 based at least in part on the RAT used by the second base station 110. For example, an NR cell and an E-UTRAN cell may have different QoE operation capabilities. In particular, an E-UTRAN cell may not support a QoE configuration for an XR service type, a QoE configuration for an MBMS service type, and/or a QoE configuration for a network slice-related service type, among other examples.

In some aspects, the UE 120, to perform the operation(s), may release or suspend (e.g., autonomously) at least one QoE configuration, of the one or more QoE configurations, based at least in part on a determination that the at least one QoE configuration is not supported by the RAT used by the second base station 110. In some aspects, the UE 120, to perform the operation(s), may resume measurement for all QoE configurations, but pause reporting for at least one QoE configuration, of the one or more QoE configurations, based at least in part on a determination that the at least one QoE configuration is not supported by the RAT used by the second base station.

In some aspects, the UE 120 may perform the operation(s) based at least in part on the indication relating to QoE, or lack thereof, in the message received from the second base station 110 as part of the procedure for resuming the connection of the UE 120.

In the resume/release scheme, if the second base station 110 does not support QoE operations (e.g., the message lacks the indication relating to QoE), then the UE 120, to perform the operation(s), may release all QoE configurations of the UE 120 (e.g., upon receiving the message). In the resume/release scheme, if the second base station 110 supports QoE operations (e.g., the message includes the indication relating to QoE), then the UE 120 may perform the operation(s) based at least in part on the indication relating to QoE. For example, if the indication indicates that the UE 120 is to resume measurement and reporting for all QoE configurations, then the UE 120, to perform the operation(s), may resume measurement (e.g., perform measurements) and reporting (e.g., generate and transmit QoE reports) for all QoE configurations of the UE 120; if the indication indicates at least one QoE configuration that is to be released by the UE 120, then the UE 120, to perform the operation(s), may release the at least one QoE configuration and resume measurement and reporting for any other QoE configurations of the UE 120; if the indication indicates at least one QoE configuration for which measurement and reporting is to be resumed, then the UE 120, to perform the operation(s), may resume measurement and reporting for the at least one QoE configuration and release any other QoE configurations of the UE 120; and/or if the indication indicates one or more new QoE configurations for the UE 120, then the UE 120, to perform the operation(s), may release all stored QoE configurations (e.g., the one or more QoE configurations received from the first base station 110) and apply (e.g., store, activate, or the like) the one or more new QoE configurations.

In the resume/suspend scheme, if the second base station 110 does not support QoE operations (e.g., the message lacks the indication relating to QoE), then the UE 120, to perform the operation(s), may suspend all QoE configurations of the UE 120 (e.g., upon receiving the message). In the resume/suspend scheme, if the second base station 110 supports QoE operations (e.g., the message includes the indication relating to QoE), then the UE 120 may perform the operation(s) based at least in part on the indication relating to QoE. For example, if the indication indicates that the UE 120 is to resume measurement and reporting for all QoE configurations, then the UE 120, to perform the operation(s), may resume measurement and reporting for all QoE configurations of the UE 120; if the indication indicates at least one QoE configuration that is to be released (or suspended) by the UE 120, then the UE 120, to perform the operation(s), may release (or suspend) the at least one QoE configuration and resume measurement and reporting for any other QoE configurations of the UE 120; and/or if the indication indicates at least one QoE configuration for which measurement and reporting is to be resumed, then the UE 120, to perform the operation(s), may resume measurement and reporting for the at least one QoE configuration and suspend any other QoE configurations of the UE 120.

In the resume/pause scheme, if the second base station 110 does not support QoE operations (e.g., the message lacks the indication relating to QoE), then the UE 120, to perform the operation(s), may resume measurement for all QoE configurations of the UE 120 and pause QoE reporting for all QoE configurations of the UE 120 (e.g., upon receiving the message). In the resume/pause scheme, if the second base station 110 supports QoE operations (e.g., the message includes the indication relating to QoE), then the UE 120 may perform the operation(s) based at least in part on the indication relating to QoE. For example, if the indication indicates that the UE 120 is to resume measurement and reporting for all QoE configurations, then the UE 120, to perform the operation(s), may resume measurement and reporting for all QoE configurations of the UE 120 (e.g., the UE 120 may perform measurements, resume SRB4, and resume QoE reporting); if the indication indicates that the UE 120 is to pause reporting for all QoE configurations, then the UE 120, to perform the operation(s), may resume measurement for all QoE configurations and pause reporting for all QoE configurations; if the indication indicates at least one QoE configuration for which the UE 120 is to pause reporting, then the UE 120, to perform the operation(s), may resume measurement for all QoE configurations, pause reporting for the at least one QoE configuration, and resume reporting for any other QoE configurations of the UE 120; and/or if the indication indicates at least one QoE configuration for which the UE 120 is to resume reporting, then the UE 120, to perform the operation(s), may resume measurement for all QoE configurations, resume reporting for the at least one QoE configuration, and pause reporting for any other QoE configurations of the UE 120.

In some aspects (e.g., in the resume/pause scheme), if the indication relating to QoE indicates that the UE 120 is to resume measurement and reporting for one or more QoE configurations of the UE 120, but an SRB for QoE reporting (e.g., SRB4) is not configured for the UE 120 by the second base station 110, then the UE 120, to perform the operation(s), may pause reporting for all QoE configurations and release the SRB configuration for QoE reporting (e.g., the SRB4 configuration) stored by the UE 120 (e.g., the SRB configuration received from the first base station 110). In some aspects (e.g., in the resume/pause scheme), if the indication relating to QoE indicates that the UE 120 is to resume measurement and reporting for one or more QoE configurations of the UE 120, but the second base station 110 releases or suspends the SRB configuration for QoE reporting (e.g., the SRB4 configuration), then the UE 120, to perform the operation(s), may pause reporting for all QoE configurations and release or suspend the SRB configuration for QoE reporting (e.g., the SRB4 configuration).

In this way, the UE 120 may perform operations, for the one or more QoE configurations of the UE 120, that are tailored to the QoE operation capabilities of the second base station 110 and/or the QoE reporting availabilities of the second base station 110. Accordingly, the operations facilitate efficient QoE reporting, thereby conserving processing resources of the UE 120 used for QoE measurement and/or network resources used for QoE reporting.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with QoE operations handling for an inactive state.

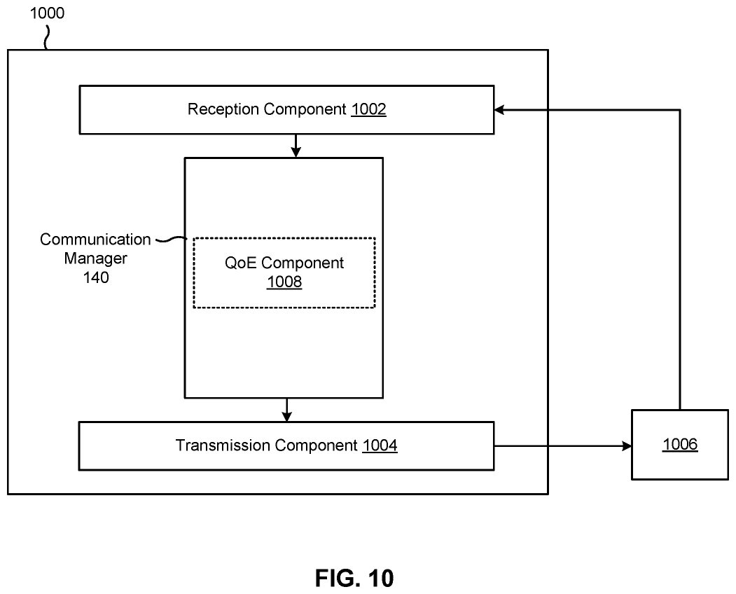

As shown in FIG. 6, in some aspects, process 600 may include receiving, from a first base station prior to entering an inactive state, one or more QoE configurations (block 610). For example, the UE (e.g., using communication manager 140 and/or reception component 1002, depicted in FIG. 10) may receive, from a first base station prior to entering an inactive state, one or more QoE configurations, as described above.

As further shown in FIG. 6, in some aspects, process 600 may include performing, based at least in part on transitioning from the inactive state to a connected state with a second base station, at least one operation for the one or more QoE configurations (block 620). For example, the UE (e.g., using communication manager 140 and/or QoE component 1008, depicted in FIG. 10) may perform, based at least in part on transitioning from the inactive state to a connected state with a second base station, at least one operation for the one or more QoE configurations, as described above.

Process 600 may include additional aspects, such as any single aspect or any combination of aspects described below and/or in connection with one or more other processes described elsewhere herein.

In a first aspect, process 600 includes receiving, from the second base station, a message that does not include an indication relating to QoE, where the message not including the indication indicates that the second base station does not support QoE operations.

In a second aspect, alone or in combination with the first aspect, the at least one operation performed by the UE includes releasing the one or more QoE configurations.

In a third aspect, alone or in combination with one or more of the first and second aspects, the at least one operation performed by the UE includes suspending the one or more QoE configurations.

In a fourth aspect, alone or in combination with one or more of the first through third aspects, the at least one operation performed by the UE includes resuming measurement for the one or more QoE configurations and pausing reporting for the one or more QoE configurations.

In a fifth aspect, alone or in combination with one or more of the first through fourth aspects, process 600 includes receiving, from the second base station, a message that includes an indication relating to QoE, where the message including the indication indicates that the second base station supports QoE operations.

In a sixth aspect, alone or in combination with one or more of the first through fifth aspects, the indication indicates that the UE is to resume measurement and reporting for all QoE configurations, and where the at least one operation performed by the UE includes resuming measurement and reporting for the one or more QoE configurations.

In a seventh aspect, alone or in combination with one or more of the first through sixth aspects, the indication indicates at least one QoE configuration, of the one or more QoE configurations, that is to be released, and where the at least one operation performed by the UE includes releasing the at least one QoE configuration and resuming measurement and reporting for any other QoE configurations of the one or more QoE configurations.

In an eighth aspect, alone or in combination with one or more of the first through seventh aspects, the indication indicates at least one QoE configuration, of the one or more QoE configurations, for which measurement and reporting is to be resumed, and where the at least one operation performed by the UE includes resuming measurement and reporting for the at least one QoE configuration and releasing any other QoE configurations of the one or more QoE configurations.

In a ninth aspect, alone or in combination with one or more of the first through eighth aspects, the indication indicates at least one QoE configuration, of the one or more QoE configurations, for which measurement and reporting is to be resumed, and where the at least one operation performed by the UE includes resuming measurement and reporting for the at least one QoE configuration and suspending any other QoE configurations of the one or more QoE configurations.

In a tenth aspect, alone or in combination with one or more of the first through ninth aspects, the indication indicates one or more new QoE configurations, and where the at least one operation performed by the UE includes releasing the one or more QoE configurations and applying the one or more new QoE configurations.

In an eleventh aspect, alone or in combination with one or more of the first through tenth aspects, the indication indicates that the UE is to pause reporting for all QoE configurations, and where the at least one operation performed by the UE includes resuming measurement for the one or more QoE configurations and pausing reporting for the one or more QoE configurations.

In a twelfth aspect, alone or in combination with one or more of the first through eleventh aspects, the indication indicates at least one QoE configuration, of the one or more QoE configurations, for which the UE is to pause reporting, and where the at least one operation performed by the UE includes resuming measurement for the one or more QoE configurations, pausing reporting for the at least one QoE configuration, and resuming reporting for any other QoE configurations of the one or more QoE configurations.

In a thirteenth aspect, alone or in combination with one or more of the first through twelfth aspects, the indication indicates at least one QoE configuration, of the one or more QoE configurations, for which the UE is to resume reporting, and where the at least one operation performed by the UE includes resuming measurement for the one or more QoE configurations, resuming reporting for the at least one QoE configuration, and pausing reporting for any other QoE configurations of the one or more QoE configurations.

In a fourteenth aspect, alone or in combination with one or more of the first through thirteenth aspects, the indication indicates that the UE is to resume measurement and reporting for at least one QoE configuration of the one or more QoE configurations, where a signaling radio bearer for QoE reporting is not configured for the UE by the second base station, and where the at least one operation performed by the UE includes pausing reporting for the at least one QoE configuration and releasing a signaling radio bearer configuration for QoE reporting of the UE.

In a fifteenth aspect, alone or in combination with one or more of the first through fourteenth aspects, the indication indicates that the UE is to resume measurement and reporting for at least one QoE configuration of the one or more QoE configurations, where a signaling radio bearer configuration for QoE reporting of the UE is released or suspended by the second base station, and where the at least one operation performed by the UE includes pausing reporting for the at least one QoE configuration and releasing or suspending the signaling radio bearer configuration for QoE reporting of the UE.

In a sixteenth aspect, alone or in combination with one or more of the first through fifteenth aspects, the at least one operation performed by the UE includes releasing or suspending at least one QoE configuration, of the one or more QoE configurations, based at least in part on a determination that the at least one QoE configuration is not supported by a radio access technology used by the second base station.

In a seventeenth aspect, alone or in combination with one or more of the first through sixteenth aspects, the at least one operation performed by the UE includes resuming measurement for the one or more QoE configurations and pausing reporting for at least one QoE configuration, of the one or more QoE configurations, based at least in part on a determination that the at least one QoE configuration is not supported by a radio access technology used by the second base station.

In an eighteenth aspect, alone or in combination with one or more of the first through seventeenth aspects, process 600 includes receiving, from the second base station, a system information message that indicates whether the second base station supports QoE operations.

In a nineteenth aspect, alone or in combination with one or more of the first through eighteenth aspects, the at least one operation performed by the UE includes releasing or suspending the one or more QoE configurations based at least in part on the system information message indicating that the second base station does not support QoE operations.

In a twentieth aspect, alone or in combination with one or more of the first through nineteenth aspects, the at least one operation performed by the UE includes resuming measurement for the one or more QoE configurations and pausing reporting for the one or more QoE configurations based at least in part on the system information message indicating that the second base station does not support QoE operations.

In a twenty-first aspect, alone or in combination with one or more of the first through twentieth aspects, the at least one operation performed by the UE includes resuming measurement and reporting for the one or more QoE configurations based at least in part on the system information message indicating that the second base station supports QoE operations.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., base station 110) performs operations associated with QoE operations handling for an inactive state.

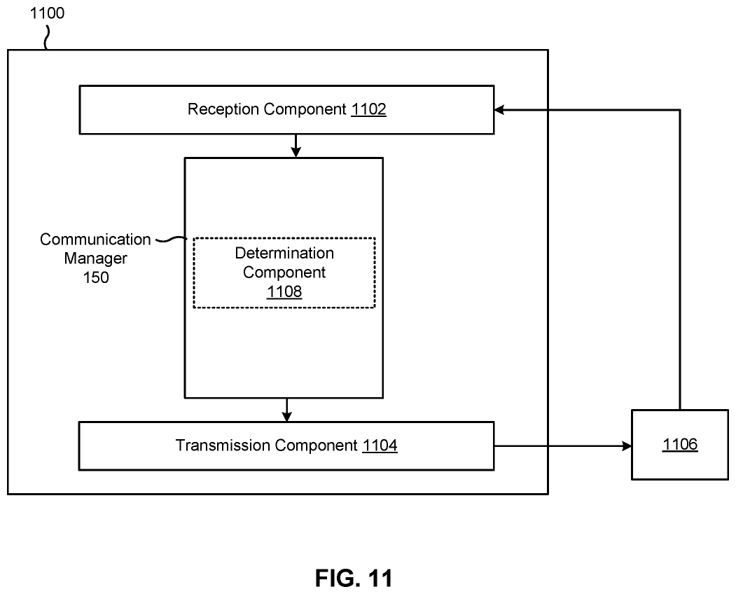

As shown in FIG. 7, in some aspects, process 700 may include receiving, from another base station that supports one or more QoE configurations of a UE, a UE context of the UE (block 710). For example, the base station (e.g., using communication manager 150 and/or reception component 1102, depicted in FIG. 11) may receive, from another base station that supports one or more QoE configurations of a UE, a UE context of the UE, as described above.

As further shown in FIG. 7, in some aspects, process 700 may include transmitting, to the UE based at least in part on the UE transitioning from an inactive state to a connected state with the base station, a message for resuming a connection of the UE with the base station (block 720). For example, the base station (e.g., using communication manager 150 and/or transmission component 1104, depicted in FIG. 11) may transmit, to the UE based at least in part on the UE transitioning from an inactive state to a connected state with the base station, a message for resuming a connection of the UE with the base station, as described above.

Process 700 may include additional aspects, such as any single aspect or any combination of aspects described below and/or in connection with one or more other processes described elsewhere herein.

In a first aspect, the message does not include an indication relating to QoE, where the message not including the indication indicates that the base station does not support QoE operations.

In a second aspect, alone or in combination with the first aspect, the message includes an indication relating to QoE, where the message including the indication indicates that the base station supports QoE operations.

In a third aspect, alone or in combination with one or more of the first and second aspects, the indication indicates that the UE is to resume measurement and reporting for all QoE configurations.

In a fourth aspect, alone or in combination with one or more of the first through third aspects, the indication indicates at least one QoE configuration, of the one or more QoE configurations, that is to be released.

In a fifth aspect, alone or in combination with one or more of the first through fourth aspects, the indication indicates at least one QoE configuration, of the one or more QoE configurations, for which measurement and reporting is to be resumed.

In a sixth aspect, alone or in combination with one or more of the first through fifth aspects, the indication indicates one or more new QoE configurations.

In a seventh aspect, alone or in combination with one or more of the first through sixth aspects, the indication indicates that the UE is to pause reporting for all QoE configurations.

In an eighth aspect, alone or in combination with one or more of the first through seventh aspects, the indication indicates at least one QoE configuration, of the one or more QoE configurations, for which the UE is to pause reporting.

In a ninth aspect, alone or in combination with one or more of the first through eighth aspects, the indication indicates at least one QoE configuration, of the one or more QoE configurations, for which the UE is to resume reporting.

In a tenth aspect, alone or in combination with one or more of the first through ninth aspects, the indication indicates that the UE is to resume measurement and reporting for at least one QoE configuration of the one or more QoE configurations, and where a signaling radio bearer for QoE reporting is not configured for the UE by the base station.

In an eleventh aspect, alone or in combination with one or more of the first through tenth aspects, the indication indicates that the UE is to resume measurement and reporting for at least one QoE configuration of the one or more QoE configurations, and where a signaling radio bearer configuration for QoE reporting of the UE is released or suspended by the base station.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with QoE operations handling for an inactive state.

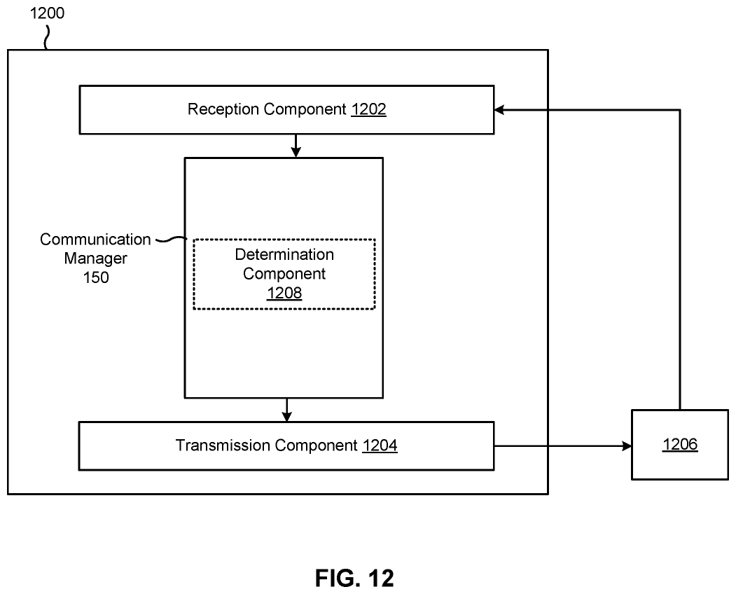

As shown in FIG. 8, in some aspects, process 800 may include receiving, from another base station, a request for a UE context, the UE context including a QoE context of the UE (block 810). For example, the base station (e.g., using communication manager 150 and/or reception component 1202, depicted in FIG. 12) may receive, from another base station, a request for a UE context, the UE context including a QoE context of the UE, as described above.

As further shown in FIG. 8, in some aspects, process 800 may include transmitting, to the other base station, the UE context including the QoE context or the UE context with the QoE context, or a portion of the QoE context, released (block 820). For example, the base station (e.g., using communication manager 150 and/or transmission component 1204, depicted in FIG. 12) may transmit, to the other base station, the UE context including the QoE context or the UE context with the QoE context, or a portion of the QoE context, released, as described above.

Process 800 may include additional aspects, such as any single aspect or any combination of aspects described below and/or in connection with one or more other processes described elsewhere herein.

In a first aspect, the UE context including the QoE context is transmitted based at least in part on the other base station supporting QoE operations in accordance with the QoE context of the UE.

In a second aspect, alone or in combination with the first aspect, the UE context with the QoE context, or the portion of the QoE context, released is transmitted based at least in part on the other base station not supporting QoE operations in accordance with the QoE context of the UE.

In a third aspect, alone or in combination with one or more of the first and second aspects, the UE context including the QoE context is transmitted regardless of whether the other base station supports QoE operations in accordance with the QoE context of the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with QoE operations handling for an inactive state.

As shown in FIG. 9, in some aspects, process 900 may include transmitting, to another base station, a request for a UE context, the UE context including a QoE context of the UE (block 910). For example, the base station (e.g., using communication manager 150 and/or transmission component 1104, depicted in FIG. 11) may transmit, to another base station, a request for a UE context, the UE context including a QoE context of the UE, as described above.

As further shown in FIG. 9, in some aspects, process 900 may include receiving, from the other base station, the UE context including the QoE context or the UE context with the QoE context, or a portion of the QoE context, released (block 920). For example, the base station (e.g., using communication manager 150 and/or reception component 1102, depicted in FIG. 11) may receive, from the other base station, the UE context including the QoE context or the UE context with the QoE context, or a portion of the QoE context, released, as described above.

Process 900 may include additional aspects, such as any single aspect or any combination of aspects described below and/or in connection with one or more other processes described elsewhere herein.

In a first aspect, the UE context including the QoE context is received based at least in part on the base station supporting QoE operations in accordance with the QoE context of the UE.

In a second aspect, alone or in combination with the first aspect, the UE context with the QoE context, or the portion of the QoE context, released is received based at least in part on the base station not supporting QoE operations in accordance with the QoE context of the UE.

In a third aspect, alone or in combination with one or more of the first and second aspects, the UE context including the QoE context is received regardless of whether the base station supports QoE operations in accordance with the QoE context of the UE.

In a fourth aspect, alone or in combination with one or more of the first through third aspects, process 900 includes discarding the QoE context in the UE context based at least in part on the base station not supporting QoE operations in accordance with the QoE context of the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a QoE component, among other examples.

In some aspects, the apparatus 1000 may be configured to perform one or more operations described herein in connection with FIG. 5. Additionally, or alternatively, the apparatus 1000 may be configured to perform one or more processes described herein, such as process 600 of FIG. 6, or a combination thereof. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The reception component 1002 may receive, from a first base station prior to entering an inactive state, one or more QoE configurations. The QoE component 1008 may perform, based at least in part on transitioning from the inactive state to a connected state with a second base station, at least one operation for the one or more QoE configurations.

The reception component 1002 may receive, from the second base station, a message that does not include an indication relating to QoE. In some aspects, the message not including the indication indicates that the second base station does not support QoE operations. The reception component 1002 may receive, from the second base station, a message that includes an indication relating to QoE. In some aspects, the message including the indication indicates that the second base station supports QoE operations. The reception component 1002 may receive, from the second base station, a system information message that indicates whether the second base station supports QoE operations. The QoE component 1008 may determine whether a QoE configuration is supported by a RAT used by the second base station.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a determination component 1108, among other examples.

In some aspects, the apparatus 1100 may be configured to perform one or more operations described herein in connection with FIG. 5. Additionally, or alternatively, the apparatus 1100 may be configured to perform one or more processes described herein, such as process 700 of FIG. 7, process 900 of FIG. 9, or a combination thereof. In some aspects, the apparatus 1100 and/or one or more components shown in FIG. 11 may include one or more components of the base station described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the base station described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the base station described above in connection with FIG. 2. In some aspects, the transmission component 1104 may be co-located with the reception component 1102 in a transceiver.

The reception component 1102 may receive, from a base station that supports one or more QoE configurations of a UE, a UE context of the UE. The transmission component 1104 may transmit, to the UE based at least in part on the UE transitioning from an inactive state to a connected state with the base station, a message for resuming a connection of the UE with the base station.

The transmission component 1104 may transmit, to a base station, a request for a UE context, the UE context including a QoE context of the UE. The reception component 1102 may receive, from the base station, the UE context including the QoE context or the UE context with the QoE context, or a portion of the QoE context, released. The determination component 1108 may discard the QoE context in the UE context based at least in part on the apparatus 1100 not supporting QoE operations in accordance with the QoE context of the UE.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a block diagram of an example apparatus 1200 for wireless communication. The apparatus 1200 may be a base station, or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include one or more of a determination component 1208, among other examples.

In some aspects, the apparatus 1200 may be configured to perform one or more operations described herein in connection with FIG. 5. Additionally, or alternatively, the apparatus 1200 may be configured to perform one or more processes described herein, such as process 800 of FIG. 8, or a combination thereof. In some aspects, the apparatus 1200 and/or one or more components shown in FIG. 12 may include one or more components of the base station described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the base station described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the base station described above in connection with FIG. 2. In some aspects, the transmission component 1204 may be co-located with the reception component 1202 in a transceiver.

The reception component 1202 may receive, from a base station, a request for a UE context, the UE context including a QoE context of the UE. The transmission component 1204 may transmit, to the base station, the UE context including the QoE context or the UE context with the QoE context, or a portion of the QoE context, released. The determination component 1208 may determine whether to transmit the UE context including the QoE context or the UE context with the QoE context, or the portion of the QoE context, released based at least in part on whether the base station supports QoE operations in accordance with the QoE context of the UE.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: receiving, from a first base station prior to entering an inactive state, one or more quality of experience (QoE) configurations; and performing, based at least in part on transitioning from the inactive state to a connected state with a second base station, at least one operation for the one or more QoE configurations.
Aspect 2: The method of Aspect 1, further comprising: receiving, from the second base station, a message that does not include an indication relating to QoE, wherein the message not including the indication indicates that the second base station does not support QoE operations.
Aspect 3: The method of Aspect 2, wherein the at least one operation performed by the UE includes releasing the one or more QoE configurations.
Aspect 4: The method of Aspect 2, wherein the at least one operation performed by the UE includes suspending the one or more QoE configurations.
Aspect 5: The method of Aspect 2, wherein the at least one operation performed by the UE includes resuming measurement for the one or more QoE configurations and pausing reporting for the one or more QoE configurations.
Aspect 6: The method of Aspect 1, further comprising: receiving, from the second base station, a message that includes an indication relating to QoE, wherein the message including the indication indicates that the second base station supports QoE operations.
Aspect 7: The method of Aspect 6, wherein the indication indicates that the UE is to resume measurement and reporting for all QoE configurations, and wherein the at least one operation performed by the UE includes resuming measurement and reporting for the one or more QoE configurations.
Aspect 8: The method of any of Aspects 6-7, wherein the indication indicates at least one QoE configuration, of the one or more QoE configurations, that is to be released, and wherein the at least one operation performed by the UE includes releasing the at least one QoE configuration and resuming measurement and reporting for any other QoE configurations of the one or more QoE configurations.
Aspect 9: The method of any of Aspects 6-8, wherein the indication indicates at least one QoE configuration, of the one or more QoE configurations, for which measurement and reporting is to be resumed, and wherein the at least one operation performed by the UE includes resuming measurement and reporting for the at least one QoE configuration and releasing any other QoE configurations of the one or more QoE configurations.
Aspect 10: The method of any of Aspects 6-9, wherein the indication indicates at least one QoE configuration, of the one or more QoE configurations, for which measurement and reporting is to be resumed, and wherein the at least one operation performed by the UE includes resuming measurement and reporting for the at least one QoE configuration and suspending any other QoE configurations of the one or more QoE configurations.
Aspect 11: The method of any of Aspects 6-10, wherein the indication indicates one or more new QoE configurations, and wherein the at least one operation performed by the UE includes releasing the one or more QoE configurations and applying the one or more new QoE configurations.
Aspect 12: The method of any of Aspects 6-11, wherein the indication indicates that the UE is to pause reporting for all QoE configurations, and wherein the at least one operation performed by the UE includes resuming measurement for the one or more QoE configurations and pausing reporting for the one or more QoE configurations.
Aspect 13: The method of any of Aspects 6-12, wherein the indication indicates at least one QoE configuration, of the one or more QoE configurations, for which the UE is to pause reporting, and wherein the at least one operation performed by the UE includes resuming measurement for the one or more QoE configurations, pausing reporting for the at least one QoE configuration, and resuming reporting for any other QoE configurations of the one or more QoE configurations.
Aspect 14: The method of any of Aspects 6-13, wherein the indication indicates at least one QoE configuration, of the one or more QoE configurations, for which the UE is to resume reporting, and wherein the at least one operation performed by the UE includes resuming measurement for the one or more QoE configurations, resuming reporting for the at least one QoE configuration, and pausing reporting for any other QoE configurations of the one or more QoE configurations.
Aspect 15: The method of any of Aspects 6-14, wherein the indication indicates that the UE is to resume measurement and reporting for at least one QoE configuration of the one or more QoE configurations, wherein a signaling radio bearer for QoE reporting is not configured for the UE by the second base station, and wherein the at least one operation performed by the UE includes pausing reporting for the at least one QoE configuration and releasing a signaling radio bearer configuration for QoE reporting of the UE.
Aspect 16: The method of any of Aspects 6-15, wherein the indication indicates that the UE is to resume measurement and reporting for at least one QoE configuration of the one or more QoE configurations, wherein a signaling radio bearer configuration for QoE reporting of the UE is released or suspended by the second base station, and wherein the at least one operation performed by the UE includes pausing reporting for the at least one QoE configuration and releasing or suspending the signaling radio bearer configuration for QoE reporting of the UE.
Aspect 17: The method of any of Aspects 1-16, wherein the at least one operation performed by the UE includes releasing or suspending at least one QoE configuration, of the one or more QoE configurations, based at least in part on a determination that the at least one QoE configuration is not supported by a radio access technology used by the second base station.
Aspect 18: The method of any of Aspects 1-17, wherein the at least one operation performed by the UE includes resuming measurement for the one or more QoE configurations and pausing reporting for at least one QoE configuration, of the one or more QoE configurations, based at least in part on a determination that the at least one QoE configuration is not supported by a radio access technology used by the second base station.
Aspect 19: The method of any of Aspects 1-18, further comprising: receiving, from the second base station, a system information message that indicates whether the second base station supports QoE operations.
Aspect 20: The method of Aspect 19, wherein the at least one operation performed by the UE includes releasing or suspending the one or more QoE configurations based at least in part on the system information message indicating that the second base station does not support QoE operations.
Aspect 21: The method of any of Aspects 19-20, wherein the at least one operation performed by the UE includes resuming measurement for the one or more QoE configurations and pausing reporting for the one or more QoE configurations based at least in part on the system information message indicating that the second base station does not support QoE operations.
Aspect 22: The method of Aspect 19, wherein the at least one operation performed by the UE includes resuming measurement and reporting for the one or more QoE configurations based at least in part on the system information message indicating that the second base station supports QoE operations.
Aspect 23: A method of wireless communication performed by a base station, comprising: receiving, from another base station that supports one or more QoE configurations of a user equipment (UE), a UE context of the UE; and transmitting, to the UE based at least in part on the UE transitioning from an inactive state to a connected state with the base station, a message for resuming a connection of the UE with the base station.
Aspect 24: The method of Aspect 23, wherein the message does not include an indication relating to QoE, wherein the message not including the indication indicates that the base station does not support QoE operations.
Aspect 25: The method of Aspect 23, wherein the message includes an indication relating to QoE, wherein the message including the indication indicates that the base station supports QoE operations.
Aspect 26: The method of Aspect 25, wherein the indication indicates that the UE is to resume measurement and reporting for all QoE configurations.
Aspect 27: The method of any of Aspects 25-26, wherein the indication indicates at least one QoE configuration, of the one or more QoE configurations, that is to be released.
Aspect 28: The method of any of Aspects 25-27, wherein the indication indicates at least one QoE configuration, of the one or more QoE configurations, for which measurement and reporting is to be resumed.
Aspect 29: The method of any of Aspects 25-28, wherein the indication indicates one or more new QoE configurations.
Aspect 30: The method of any of Aspects 25-29, wherein the indication indicates that the UE is to pause reporting for all QoE configurations.
Aspect 31: The method of any of Aspects 25-30, wherein the indication indicates at least one QoE configuration, of the one or more QoE configurations, for which the UE is to pause reporting.
Aspect 32: The method of any of Aspects 25-31, wherein the indication indicates at least one QoE configuration, of the one or more QoE configurations, for which the UE is to resume reporting.
Aspect 33: The method of any of Aspects 25-32, wherein the indication indicates that the UE is to resume measurement and reporting for at least one QoE configuration of the one or more QoE configurations, and wherein a signaling radio bearer for QoE reporting is not configured for the UE by the base station.
Aspect 34: The method of any of Aspects 25-33, wherein the indication indicates that the UE is to resume measurement and reporting for at least one QoE configuration of the one or more QoE configurations, and wherein a signaling radio bearer configuration for QoE reporting of the UE is released or suspended by the base station.
Aspect 35: A method of wireless communication performed by a base station, comprising: receiving, from another base station, a request for a user equipment (UE) context, the UE context including a quality of experience (QoE) context of the UE; and transmitting, to the other base station, the UE context including the QoE context or the UE context with the QoE context, or a portion of the QoE context, released.
Aspect 36: The method of Aspect 35, wherein the UE context including the QoE context is transmitted based at least in part on the other base station supporting QoE operations in accordance with the QoE context of the UE.
Aspect 37: The method of Aspect 35, wherein the UE context with the QoE context, or the portion of the QoE context, released is transmitted based at least in part on the other base station not supporting QoE operations in accordance with the QoE context of the UE.
Aspect 38: The method of Aspect 35, wherein the UE context including the QoE context is transmitted regardless of whether the other base station supports QoE operations in accordance with the QoE context of the UE.
Aspect 39: A method of wireless communication performed by a base station, comprising: transmitting, to another base station, a request for a user equipment (UE) context, the UE context including a quality of experience (QoE) context of the UE; and receiving, from the other base station, the UE context including the QoE context or the UE context with the QoE context, or a portion of the QoE context, released.
Aspect 40: The method of Aspect 39, wherein the UE context including the QoE context is received based at least in part on the base station supporting QoE operations in accordance with the QoE context of the UE.
Aspect 41: The method of Aspect 39, wherein the UE context with the QoE context, or the portion of the QoE context, released is received based at least in part on the base station not supporting QoE operations in accordance with the QoE context of the UE.
Aspect 42: The method of Aspect 39, wherein the UE context including the QoE context is received regardless of whether the base station supports QoE operations in accordance with the QoE context of the UE.
Aspect 43: The method of any of Aspects 39 or 42, further comprising: discarding the QoE context in the UE context based at least in part on the base station not supporting QoE operations in accordance with the QoE context of the UE.
Aspect 44: An apparatus for wireless communication at a device, comprising a processor; memory coupled with the processor; and instructions stored in the memory and executable by the processor to cause the apparatus to perform the method of one or more Aspects of Aspects 1-22.
Aspect 45: A device for wireless communication, comprising a memory and one or more processors coupled to the memory, the memory and the one or more processors configured to perform the method of one or more Aspects of Aspects 1-22.
Aspect 46: An apparatus for wireless communication, comprising at least one means for performing the method of one or more Aspects of Aspects 1-22.
Aspect 47: A non-transitory computer-readable medium storing code for wireless communication, the code comprising instructions executable by a processor to perform the method of one or more Aspects of Aspects 1-22.
Aspect 48: A non-transitory computer-readable medium storing a set of instructions for wireless communication, the set of instructions comprising one or more instructions that, when executed by one or more processors of a device, cause the device to perform the method of one or more Aspects of Aspects 1-22.
Aspect 49: An apparatus for wireless communication at a device, comprising a processor; memory coupled with the processor; and instructions stored in the memory and executable by the processor to cause the apparatus to perform the method of one or more Aspects of Aspects 23-34.
Aspect 50: A device for wireless communication, comprising a memory and one or more processors coupled to the memory, the memory and the one or more processors configured to perform the method of one or more Aspects of Aspects 23-34.
Aspect 51: An apparatus for wireless communication, comprising at least one means for performing the method of one or more Aspects of Aspects 23-34.
Aspect 52: A non-transitory computer-readable medium storing code for wireless communication, the code comprising instructions executable by a processor to perform the method of one or more Aspects of Aspects 23-34.
Aspect 53: A non-transitory computer-readable medium storing a set of instructions for wireless communication, the set of instructions comprising one or more instructions that, when executed by one or more processors of a device, cause the device to perform the method of one or more Aspects of Aspects 23-34.
Aspect 54: An apparatus for wireless communication at a device, comprising a processor; memory coupled with the processor; and instructions stored in the memory and executable by the processor to cause the apparatus to perform the method of one or more Aspects of Aspects 35-38.
Aspect 55: A device for wireless communication, comprising a memory and one or more processors coupled to the memory, the memory and the one or more processors configured to perform the method of one or more Aspects of Aspects 35-38.
Aspect 56: An apparatus for wireless communication, comprising at least one means for performing the method of one or more Aspects of Aspects 35-38.
Aspect 57: A non-transitory computer-readable medium storing code for wireless communication, the code comprising instructions executable by a processor to perform the method of one or more Aspects of Aspects 35-38.
Aspect 58: A non-transitory computer-readable medium storing a set of instructions for wireless communication, the set of instructions comprising one or more instructions that, when executed by one or more processors of a device, cause the device to perform the method of one or more Aspects of Aspects 35-38.
Aspect 59: An apparatus for wireless communication at a device, comprising a processor; memory coupled with the processor; and instructions stored in the memory and executable by the processor to cause the apparatus to perform the method of one or more Aspects of Aspects 39-43.
Aspect 60: A device for wireless communication, comprising a memory and one or more processors coupled to the memory, the memory and the one or more processors configured to perform the method of one or more Aspects of Aspects 39-43.
Aspect 61: An apparatus for wireless communication, comprising at least one means for performing the method of one or more Aspects of Aspects 39-43.
Aspect 62: A non-transitory computer-readable medium storing code for wireless communication, the code comprising instructions executable by a processor to perform the method of one or more Aspects of Aspects 39-43.
Aspect 63: A non-transitory computer-readable medium storing a set of instructions for wireless communication, the set of instructions comprising one or more instructions that, when executed by one or more processors of a device, cause the device to perform the method of one or more Aspects of Aspects 39-43.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive, from a first base station prior to entering an inactive state, one or more quality of experience (QoE) configurations; and
perform, based at least in part on transitioning from the inactive state to a connected state with a second base station, at least one operation for the one or more QoE configurations.

2. The UE of claim 1, wherein the one or more processors are further configured to:
receive, from the second base station, a message that does not include an indication relating to QoE,
wherein the message not including the indication indicates that the second base station does not support QoE operations.

3. The UE of claim 2, wherein the at least one operation performed by the UE includes releasing the one or more QoE configurations.

4. The UE of claim 2, wherein the at least one operation performed by the UE includes suspending the one or more QoE configurations.

5. The UE of claim 2, wherein the at least one operation performed by the UE includes resuming measurement for the one or more QoE configurations and pausing reporting for the one or more QoE configurations.

6. The UE of claim 1, wherein the one or more processors are further configured to:
receive, from the second base station, a message that includes an indication relating to QoE, wherein the message including the indication indicates that the second base station supports QoE operations.

7. The UE of claim 6, wherein the indication indicates that the UE is to resume measurement and reporting for all QoE configurations, and
wherein the at least one operation performed by the UE includes resuming measurement and reporting for the one or more QoE configurations.

8. The UE of claim 6, wherein the indication indicates at least one QoE configuration, of the one or more QoE configurations, that is to be released, and
wherein the at least one operation performed by the UE includes releasing the at least one QoE configuration and resuming measurement and reporting for any other QoE configurations of the one or more QoE configurations.

9. The UE of claim 6, wherein the indication indicates at least one QoE configuration, of the one or more QoE configurations, for which measurement and reporting is to be resumed, and
wherein the at least one operation performed by the UE includes resuming measurement and reporting for the at least one QoE configuration and releasing any other QoE configurations of the one or more QoE configurations.

10. The UE of claim 6, wherein the indication indicates at least one QoE configuration, of the one or more QoE configurations, for which measurement and reporting is to be resumed, and
wherein the at least one operation performed by the UE includes resuming measurement and reporting for the at least one QoE configuration and suspending any other QoE configurations of the one or more QoE configurations.

11. The UE of claim 6, wherein the indication indicates one or more new QoE configurations, and
wherein the at least one operation performed by the UE includes releasing the one or more QoE configurations and applying the one or more new QoE configurations.

12. The UE of claim 6, wherein the indication indicates that the UE is to pause reporting for all QoE configurations, and
wherein the at least one operation performed by the UE includes resuming measurement for the one or more QoE configurations and pausing reporting for the one or more QoE configurations.

13. The UE of claim 6, wherein the indication indicates at least one QoE configuration, of the one or more QoE configurations, for which the UE is to pause reporting, and
wherein the at least one operation performed by the UE includes resuming measurement for the one or more QoE configurations, pausing reporting for the at least one QoE configuration, and resuming reporting for any other QoE configurations of the one or more QoE configurations.

14. The UE of claim 6, wherein the indication indicates at least one QoE configuration, of the one or more QoE configurations, for which the UE is to resume reporting, and
wherein the at least one operation performed by the UE includes resuming measurement for the one or more QoE configurations, resuming reporting for the at least one QoE configuration, and pausing reporting for any other QoE configurations of the one or more QoE configurations.

15. The UE of claim 6, wherein the indication indicates that the UE is to resume measurement and reporting for at least one QoE configuration of the one or more QoE configurations,
wherein a signaling radio bearer for QoE reporting is not configured for the UE by the second base station, and
wherein the at least one operation performed by the UE includes pausing reporting for the at least one QoE configuration and releasing a signaling radio bearer configuration for QoE reporting of the UE.

16. The UE of claim 6, wherein the indication indicates that the UE is to resume measurement and reporting for at least one QoE configuration of the one or more QoE configurations,
wherein a signaling radio bearer configuration for QoE reporting of the UE is released or suspended by the second base station, and
wherein the at least one operation performed by the UE includes pausing reporting for the at least one QoE configuration and releasing or suspending the signaling radio bearer configuration for QoE reporting of the UE.

17. The UE of claim 1, wherein the at least one operation performed by the UE includes releasing or suspending at least one QoE configuration, of the one or more QoE configurations, based at least in part on a determination that the at least one QoE configuration is not supported by a radio access technology used by the second base station.

18. The UE of claim 1, wherein the at least one operation performed by the UE includes resuming measurement for the one or more QoE configurations and pausing reporting for at least one QoE configuration, of the one or more QoE configurations, based at least in part on a determination that the at least one QoE configuration is not supported by a radio access technology used by the second base station.

19. The UE of claim 1, wherein the one or more processors are further configured to:
receive, from the second base station, a system information message that indicates whether the second base station supports QoE operations.

20. The UE of claim 19, wherein the at least one operation performed by the UE includes releasing or suspending the one or more QoE configurations based at least in part on the system information message indicating that the second base station does not support QoE operations.

21. The UE of claim 19, wherein the at least one operation performed by the UE includes resuming measurement for the one or more QoE configurations and pausing reporting for the one or more QoE configurations based at least in part on the system information message indicating that the second base station does not support QoE operations.

22. The UE of claim 19, wherein the at least one operation performed by the UE includes resuming measurement and reporting for the one or more QoE configurations based at least in part on the system information message indicating that the second base station supports QoE operations.

23. A base station for wireless communication, comprising:
a memory; and
one or more processors, coupled to the memory, configured to:
receive, from another base station that supports one or more quality of experience (QoE) configurations of a user equipment (UE), a UE context of the UE; and
transmit, to the UE based at least in part on the UE transitioning from an inactive state to a connected state with the base station, a message for resuming a connection of the UE with the base station.

24. The base station of claim 23, wherein the message does not include an indication relating to QoE,
wherein the message not including the indication indicates that the base station does not support QoE operations.

25. The base station of claim 23, wherein the message includes an indication relating to QoE,
wherein the message including the indication indicates that the base station supports QoE operations.

26. The base station of claim 25, wherein the indication indicates at least one of: that the UE is to resume measurement and reporting for all QoE configurations;
at least one QoE configuration, of the one or more QoE configurations, that is to be released;
at least one QoE configuration, of the one or more QoE configurations, for which measurement and reporting is to be resumed;
one or more new QoE configurations;
that the UE is to pause reporting for all QoE configurations;
at least one QoE configuration, of the one or more QoE configurations, for which the UE is to pause reporting;
at least one QoE configuration, of the one or more QoE configurations, for which the UE is to resume reporting;
that the UE is to resume measurement and reporting for at least one QoE configuration of the one or more QoE configurations,
wherein a signaling radio bearer for QoE reporting is not configured for the UE by the base station; or
that the UE is to resume measurement and reporting for at least one QoE configuration of the one or more QoE configurations;
wherein a signaling radio bearer configuration for QoE reporting of the UE is released or suspended by the base station.

27-34. (canceled)

35. A base station for wireless communication, comprising:
a memory; and
one or more processors, coupled to the memory, configured to:
receive, from another base station, a request for a user equipment (UE) context, the UE context including a quality of experience (QoE) context of the UE; and
transmit, to the other base station, the UE context including the QoE context or the UE context with the QoE context, or a portion of the QoE context, released.

36. The base station of claim 35, wherein: the UE context including the QoE context is transmitted based at least in part on the other base station supporting QoE operations in accordance with the QoE context of the UE;
the UE context with the QoE context, or the portion of the QoE context, released is transmitted based at least in part on the other base station not supporting QoE operations in accordance with the QoE context of the UE; or
the UE context including the QoE context is transmitted regardless of whether the other base station supports QoE operations in accordance with the QoE context of the UE.

37-38. (canceled)

39. A base station for wireless communication, comprising:
a memory; and
one or more processors, coupled to the memory, configured to:
transmit, to another base station, a request for a user equipment (UE) context, the UE context including a quality of experience (QoE) context of the UE; and
receive, from the other base station, the UE context including the QoE context or the UE context with the QoE context, or a portion of the QoE context, released.

40-43. (canceled)

44. A method of wireless communication performed by a user equipment (UE), comprising:
receiving, from a first base station prior to entering an inactive state, one or more quality of experience (QoE) configurations; and
performing, based at least in part on transitioning from the inactive state to a connected state with a second base station, at least one operation for the one or more QoE configurations.

45-86. (canceled)
